(19) United States
(12) Patent Application Publication
(10) Pub. No.: US 2023/0231167 A1
(43) Pub. Date: Jul. 20, 2023

(54) DEVICE AND METHOD FOR DISTRIBUTING THE POWER OF FUEL CELL SYSTEMS IN A VEHICLE

(71) Applicants: AUDI AG, Ingolstadt (DE); VOLKSWAGEN AG, Wolfsburg (DE)

(72) Inventors: Markus RUF, Waldstetten (DE); Martin ARENDT, Hamburg (DE); Hannah STAUB, Karlsdorf-Neuthard (DE); Patrick ARNOLD, Braunschweig (DE)

(21) Appl. No.: 18/001,240

(22) PCT Filed: Jul. 15, 2021
(86) PCT No.: PCT/EP2021/069788

§ 371 Date: Dec. 8, 2022

(30) Foreign Application Priority Data
Jul. 21, 2020 (DE) 10 2020 119 096.4

(51) Int. Cl. H01M 8/04858; H01M 8/249; B60L 58/40

(52) U.S. Cl. CPC H01M 8/04925; H01M 8/249; B60L 58/40; H01M 2250/20

(57) ABSTRACT

An apparatus for splitting the power of fuel cell systems in a vehicle comprises: a first fuel cell system and at least one further fuel cell system, which are configured to convert hydrogen and oxygen into water in order to generate electrical energy therefrom, and a controller unit, which is configured to actuate the first fuel cell system and the further fuel cell system with an electrical signal. The apparatus is configured to actuate the first fuel cell system and the further fuel cell system with the electrical signal in time offset fashion.

### BACKGROUND

### Technical Field

Embodiments of the invention relate to a device for distributing the power of fuel cell systems in a vehicle, the device comprising: a first fuel cell system and at least one further fuel cell system, which are configured to convert hydrogen and oxygen to water in order to generate electrical energy therefrom, and a control unit, which is configured to activate the first fuel cell system and the further fuel cell system by way of an electrical signal.

### Description of the Related Art

A fuel cell system comprising fuel cell modules is known from document US 2005/112428 A1, which are each controlled by a local controller. A master controller controls each of the local controllers in accordance with overall system requirements.

A fuel cell system comprising fuel modules is known from document U.S. Pat. No. 7,166,985 B1, which are networked so that each module is connected to a master controller.

A fuel cell system is known from document WO 2004/100298 A1, which comprises a pulsing switch, a controller and voltage clamping devices.

In a vehicle, fuel cell systems are used for generating electrical energy, the energy being converted into movement by means of an electric drive or being temporarily stored on an intermediate basis in a battery system.

A fuel cell system can be formed of one or more fuel cells. Fuel cells utilize the chemical reaction of a fuel, for example hydrogen, with oxygen to water so as to generate electrical energy. Fuel cells comprise what is known as a membrane electrode assembly (MEA) as the core component, which is formed of an ion-conducting membrane and a respective catalytic electrode (anode and cathode) arranged on the two sides of the membrane. The electrode typically comprises supported precious metals, in particular platinum, which serve as catalysts. A fuel cell is generally formed of a plurality of MEAs arranged in a stack.

Such a fuel cell system is set to be operated at a constant load point. Various power distribution options between the fuel cell system and the battery system are possible. In the case of multiple fuel cell systems, a power distribution is often set in such a way that all active systems are operated at identical power. However, such a fuel cell system and a corresponding battery system are subject to continuously progressing (reversible) degradation.

As a result, one has to weigh which aging effect is assigned to which component (fuel cell system or battery system). All measures, however, have a direct negative impact on the hydrogen consumption.

During operation of a fuel cell system, the electrode surfaces (i.e., the catalyst surfaces) of a fuel cell assigned to the system are passivated as a function of the cell voltage over time by way of platinum oxide loadings (PtO₂, PtO₄, or PtOₓ for short). As a result, the kinetic losses of the fuel cell increase, and the stack voltage decreases slightly with increasing operating time, at the same target current. This PtOₓ film formation process cannot be prevented and is part of the normal operation. The greater the PtOₓ loading, the more extensive are the voltage losses. The PtOₓ-based voltage loss behaves logarithmically. As a result of a change of the load point, a new cell voltage forms, and PtOₓ conversion processes take place. A switch to a higher voltage forms more PtOₓ deposits, and a switch to a lower voltage partially dissolves PtOₓ deposits. The film formation and dissolution process is never completed, but always asymptotically strives to achieve a new electrochemical balance. To completely dissolve the PtOₓ, it is customary to switch off or discharge the fuel cell system. Additionally, it is possible to influence the cell voltage by depletion of air or drying out of the membrane (less power). These methods, however, all result in the fuel cell system being temporarily limited in terms of supplying power, and dissolve PtOₓ only briefly.

During operation, the power deviating from the target power therefore generally has to be compensated for by way of battery backup. A battery of the battery system is consequently subjected to higher loading or aging. In some circumstances, a larger battery has to be used for this purpose so as to achieve the target power. This creates additional costs.

### BRIEF SUMMARY

Some embodiments provide an improved power distribution of fuel cell systems in a vehicle so that the battery system does not experience additional loading, and an efficient conversion of PtOₓ is ensured.

A device is thus described for distributing the power of fuel cell systems in a vehicle, the device comprising: a first fuel cell system and at least one further fuel cell system, which are configured to convert hydrogen and oxygen to water so as to generate electrical energy therefrom, and a control unit, which is configured to activate the first fuel cell system and the further fuel cell system by way of an electrical signal. It is provided that the device is furthermore configured to activate the first fuel cell system and the further fuel cell system by way of the electrical signal with temporal offset.

As a result of the temporally offset electrical signal, the fuel cell systems are activated or operated differently from one another. This makes it possible to provide a temporally varying power distribution between the first fuel cell system and the further fuel cell system.

In particular, the electrical energy generated by the first fuel cell system and the further fuel cell system, in particular a first electrical current generated by the first fuel cell system and a further electrical current generated by the further fuel cell system, can be modulated by the electrical signal. This makes it possible to set the currents of the fuel cell systems differently from one another.

Due to the temporally offset activation of the first fuel cell system and of the further fuel cell system by way of the electrical signal, the first electrical current and the further electrical current can be modulated such that a total power, made up of a first electrical power generated by the first fuel cell system and a further electrical power generated by the further fuel cell system, is at least partially constant over time, or corresponds to a predefined power requirement. For example, the further fuel cell system can compensate for a loss of power of the first fuel cell system during the PtOₓ conversion, and vice versa. The overall power of the fuel cell systems is thereby maintained at a constant level, so that no additional power compensation from a battery system is necessary. The battery system thus does not experience increased loading. As a result, no hardware adaption is necessary, only a changed operating setting for operating the fuel cell systems.

In this connection, a temporally offset oscillation can be applied to the first electrical current and the further electrical current by the electrical signal.

Due to the applied temporally offset oscillation of the first electrical current and of the further electrical current, a voltage in the first fuel cell system and a voltage in the further fuel cell system can be temporally varied, and in particular increased or decreased. PtOₓ films are formed more slowly than they are dissolved. The continuous PtOₓ conversion thus results in a lower share of PtOₓ, and thus a higher efficiency, for each individual fuel cell system. Furthermore, the hydrogen consumption of the fuel cell systems can be reduced, and the efficiency increased.

The control unit can furthermore comprise a modulator, which is configured to generate the electrical signal. The modular can generate the electrical signal by means of amplitude modulation, frequency modulation, phase modulation, pulse width modulation and/or the like, so as to modulate the first electrical current and the further electrical current.

The first fuel cell system and the further fuel cell system can each comprise at least one fuel cell including a membrane electrode assembly and a catalyst.

As described above, the catalyst can comprise platinum.

The device can furthermore comprise at least one hydrogen storage tank, which is configured to provide hydrogen to the first fuel cell system and/or the further fuel cell system.

The device can furthermore comprise at least one battery system, which is configured to store the electrical energy generated by the first fuel cell system and/or the further fuel cell system and to provide stored electrical energy.

The above object is also achieved by a method for distributing the power of fuel cell systems in a vehicle, comprising the following steps:
converting hydrogen and oxygen to water by a first fuel cell system and by at least one further fuel cell system so as to generate electrical energy therefrom; and
activating the first fuel cell system and the further fuel cell system by way of an electrical signal by a control unit,
the first fuel cell system and the further fuel cell system being activated by way of the electrical signal with temporal offset.

The temporally offset activation makes it possible to operate the first fuel cell system and the further fuel cell system differently, so that a temporally varying power distribution between the fuel cell systems is achieved.

The electrical energy generated by the first fuel cell system and the further fuel cell system, in particular a first electrical current generated by the first fuel cell system and a further electrical current generated by the further fuel cell system, is modulated by the electrical signal.

Due to the temporally offset activation of the first fuel cell system and of the further fuel cell system by way of the electrical signal, the first electrical current and the second electrical current can be modulated such that a total power, made up of a first electrical power generated by the first fuel cell system and a further electrical power generated by the further fuel cell system, is at least partially constant over time, or corresponds to a predefined power requirement. The drop in power of the first fuel cell system resulting from the PtOₓ conversion can be compensated for by the further fuel cell system, and vice versa. No further hardware adaptation is necessary for this purpose. Only the operating settings for the first fuel cell system and the further fuel cell system are adapted by means of the electrical signal. A battery system thus does not experience increased loading. Consequently, it is also not necessary to use a larger battery or the like to achieve a predefined target power.

A temporally offset oscillation can be applied to the first electrical current and to the further electrical current by the electrical signal.

The method can also comprise a step for providing hydrogen for the first fuel cell system and/or for the further fuel cell system from a hydrogen storage tank.

### BRIEF DESCRIPTION OF THE SEVERAL VIEWS OF THE DRAWINGS

Further advantages and details will be apparent from the following description of embodiments with reference to the figures.

FIG. 1 shows a simplified and schematic representative illustration of an embodiment of a device for distributing the power of fuel cell systems in a vehicle.

FIG. 2 shows a simplified and schematic illustration of an embodiment of a temporal progression of electrical powers of the fuel cell systems of the device.

FIG. 3 shows a simplified and schematic illustration of an embodiment of a temporal progression of hydrogen consumption of the device.

FIG. 4 shows a flow chart of an embodiment of a method for distributing the power of fuel cell systems in a vehicle.

### DETAILED DESCRIPTION

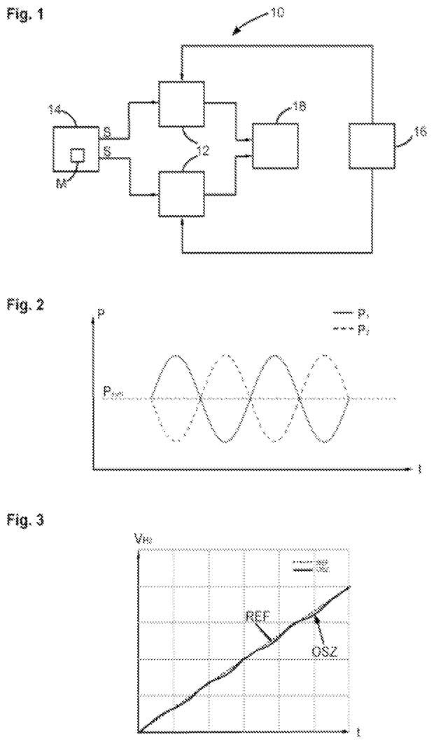

FIG. 1 shows a simplified and schematic representative illustration of an embodiment of a device 10 for distributing the power of fuel cell systems 12 in a vehicle. The device 10 comprises a first fuel cell system 12 and at least one further, second fuel cell system 12. The first fuel cell system 12 and the second fuel cell system 12 convert hydrogen and oxygen to water so as to generate electrical energy therefrom. The device 10, however, is not limited to two fuel cell systems 12 and can comprise further fuel cell systems 12. The electrical energy generated by the fuel cell systems 12 can be supplied to an electric motor of the vehicle, or can be stored in a battery system 18 of the device 10.

The device 10 furthermore comprises a control unit 14, which activates the first fuel cell system 12 and the second fuel cell system 12 by way of an electrical signal S. This is illustrated in a simplified manner by the arrows in FIG. 1.

The first fuel cell system 12 and the second fuel cell system 12 are activated by way of the electrical signal S with temporal offset, that is, they are operated differently from one another. This makes it possible to implement a temporally varying power distribution of the fuel cell systems 12. The electrical energy generated by the first fuel cell system 12 and the second fuel cell system 12, in particular a first electrical current generated by the first fuel cell system 12 and a further, second electrical current generated by the second fuel cell system 12, can be modulated by the electrical signal S.

As a result of the temporally offset activation of the first fuel cell system 12 and of the second fuel cell system 12 by way of the electrical signal S, the first electrical current and the second electrical current can be modulated such that a total power Pₛᵤₘ, made up of a first electrical power P₁ generated by the first fuel cell system 12 and a further, second electrical power P₂ generated by the second fuel cell system 12, is at least partially constant over time, or corresponds to a predefined power requirement. For example, the drop in power of the first fuel cell system 12 resulting during a conversion of platinum oxide (PtOₓ) can be compensated for by the second fuel cell system 12, and vice versa.

FIG. 2 shows the temporal progression of the first electrical power P₁ and of the second electrical power P₂ of the first fuel cell system 12 and of the second fuel cell system 12 in a simplified illustration. The temporally offset activation and the resultant temporally offset modulation of the first current and of the second current, and thus of the first electrical power P₁ and of the second electrical power P₂ result in the at least partially constant sum power Pₛᵤₘ over time. For this reason, no additional power compensation from the battery system 18 is required.

In particular, a temporally offset oscillation OSZ can be applied to the first electrical current and the second electrical current by the electrical signal S. This, however, is not limiting, and further forms of modulation, such as, for example, rectangular pulses and/or the like, are possible.

As a result of the temporally offset oscillation OSZ of the first electrical current and the second electrical current, a voltage in the first fuel cell system 12 and a voltage in the second fuel cell system 12 can be varied over time, and in particular increased or decreased. In other words, the temporally offset oscillation OSZ applied to the first current and the second current transfers to the respective voltage in the first fuel cell system 12 and the second fuel cell system 12. Since PtOₓ films dissolve more quickly than they form, an alternating change in the voltage in the particular fuel cell system 12 overall can allow more PtOₓ to be dissolved than formed. On average, this also results in lower power losses from PtOₓ. This increases the performance and the efficiency of the particular fuel cell system 12. In the case of a period duration of less than 2 minutes, a gain in efficiency of more than 1% per fuel cell system 12 can be achieved. Consequently, the hydrogen consumption of the device 10 is also reduced, which is illustrated in FIG. 3. FIG. 3 shows the temporal progression of the hydrogen consumption V_{H2} of the device 10, which is denoted by OSZ, compared to a reference hydrogen consumption V_{H2} of a conventional fuel cell system having no applied oscillation, which is denoted by REF. When comparing the curves, it is evident that hydrogen can be saved at least temporarily by applying the oscillation. This is indicated by the arrow in FIG. 3, or by areas in which the curve OSZ extends below the reference line REF.

In another embodiment, it is also possible to integrate three fuel cell systems 12 or more. In this way, the efficiency of the individual fuel cell systems 12 can be further increased.

The control unit 14 can furthermore comprise a modulator M, which generates the electrical signal S. Various modulation methods can be used in the process so as to generate the electrical signal S, such as, for example, amplitude modulation, frequency modulation, phase modulation and/or the like.

The first fuel cell system 12 and the further, second fuel cell system 12 can in each case comprise at least one fuel cell, the one membrane electrode assembly and a catalyst.

The catalyst can comprise platinum.

The device 10 can furthermore comprise a hydrogen storage tank 16, which provides hydrogen to the first fuel cell system 12 and/or the further, second fuel cell system 12. This is illustrated by the corresponding arrows in FIG. 1.

The device 10 can also comprise the battery system 18, as described above, which stores the electrical energy generated by the respective fuel cell systems 12 and supplies stored energy, for example, to the electric motor of the vehicle.

In one embodiment, the temporally offset oscillation can also be applied to an electrical current of the battery system 18 by activation by way of the electrical signal S. This can further simplify the controllability.

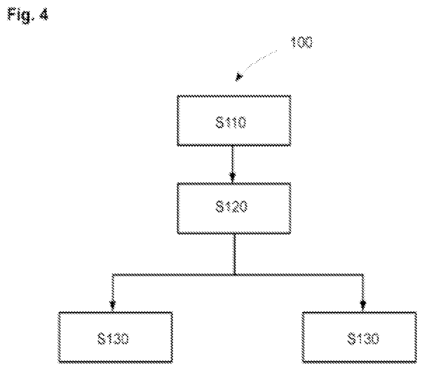

FIG. 4 shows a simplified and schematic flow chart of a method 100 for distributing the power of fuel cell systems 12 in a vehicle.

In step S120, hydrogen and oxygen are converted to water by a first fuel cell system 12 and by at least one further, second fuel cell system 12 so as to generate electrical energy therefrom.

In step S130, the first fuel cell system 12 and the second fuel cell system 12 are activated by way of a respective electrical signal S by a control unit 14.

The first fuel cell system 12 and the second fuel cell system 12 are activated by way of the electrical signal S with temporal offset. In this way, the power distribution can be temporally varied between the first fuel cell system 12 and the second fuel cell system.

The electrical energy generated by the first fuel cell system 12 and the second fuel cell system 12, in particular a first electrical current generated by the first fuel cell system 12 and a further, second electrical current generated by the second fuel cell system 12, can be modulated by the electrical signal S.

The temporally offset activation of the first fuel cell system 12 and of the second fuel cell system 12 by way of the electrical signal S makes it possible to modulate the first electrical current and the second electrical current such that a total power Pₛᵤₘ, made up of a first electrical power P₁ generated by the first fuel cell system 12 and a further, second electrical power P₂ generated by the second fuel cell system 12, is at least partially constant over time, or corresponds to a predefined power requirement.

A temporally offset oscillation OSZ can be applied to the first electrical current and to the second electrical current by the electrical signal S.

In step S110, hydrogen can be provided by a hydrogen storage tank 18 for the first fuel cell system 12 and/or for the second fuel cell system 12.

Aspects of the various embodiments described above can be combined to provide further embodiments. In general, in the following claims, the terms used should not be construed to limit the claims to the specific embodiments disclosed in the specification and the claims, but should be construed to include all possible embodiments along with the full scope of equivalents to which such claims are entitled.

1. A device for distributing power of fuel cell systems in a vehicle, the device comprising:
a first fuel cell system and at least one further fuel cell system, which are configured to convert hydrogen and oxygen to water so as to generate electrical energy therefrom; and
a control unit, which is configured to activate the first fuel cell system and the further fuel cell system by way of an electrical signal,
wherein the device configured to activate the first fuel cell system and the further fuel cell system by way of the electrical signal with temporal offset.

2. The device according to claim 1, wherein the device is configured to modulate the electrical energy generated by the first fuel cell system and the further fuel cell system by the electrical signal.

3. The device according to claim 2, wherein the device is configured, as a result of the temporally offset activation of the first fuel cell system and of the further fuel cell system by way of the electrical signal, to modulate the first electrical current and the further electrical current such that a total power, made up of a first electrical power generated by the first fuel cell system and a further electrical power generated by the further fuel cell system, is at least partially constant over time, or corresponds to a predefined power requirement.

4. The device according to claim 2, wherein the device is configured to apply a temporally offset oscillation to the first electrical current and to the further electrical current by the electrical signal.

5. The device according to claim 4, wherein, as a result of the applied temporally offset oscillation of the first electrical current and of the further electrical current, a voltage in the first fuel cell system and a voltage in the further fuel cell system are temporarily varied.

6. The device according to claim 1, wherein the control unit comprises a modulator, which is configured to generate the electrical signal.

7. The device according to claim 1, wherein the first fuel cell system and the further fuel cell system each comprise at least one fuel cell including a membrane electrode assembly and a catalyst.

8. The device according to claim 7, wherein the catalyst comprises platinum.

9. The device according to claim 1, further comprising at least one hydrogen storage tank, which is configured to provide hydrogen to the first fuel cell system and/or the further fuel cell system.

10. The device according to claim 1, further comprising at least one battery system, which is configured to store the electrical energy generated by the first fuel cell system and/or the further fuel cell system and to provide stored electrical energy.

11. A method for distributing power of fuel cell systems in a vehicle, comprising:
converting hydrogen and oxygen to water by a first fuel cell system and by at least one further fuel cell system to generate electrical energy therefrom; and
activating the first fuel cell system and the further fuel cell system by way of an electrical signal by a control unit,
the first fuel cell system and the further fuel cell system being activated by way of the electrical signal with temporal offset.

12. The method according to claim 11, wherein electrical energy generated by the first fuel cell system and the further fuel cell system are modulated by the electrical signal.

13. The method according to claim 12, wherein, as a result of the temporally offset activation of the first fuel cell system and of the further fuel cell system by way of the electrical signal, the first electrical current and the second electrical current are modulated such that a total power, made up of a first electrical power generated by the first fuel cell system and a further electrical power generated by the further fuel cell system, is at least partially constant over time, or corresponds to a predefined power requirement.

14. The method according to claim 13, wherein a temporally offset oscillation is applied to the first electrical current and to the further electrical current by the electrical signal.

15. The method according to claim 11, further comprising providing hydrogen for the first fuel cell system and/or for the further fuel cell system by a hydrogen storage tank.

16. The method according to claim 11, wherein a first electrical current generated by the first fuel cell system and a further electrical current generated by the further fuel cell system are modulated by the electrical signal.

17. The device according to claim 1, wherein the device is configured to modulate a first electrical current generated by the first fuel cell system and a further electrical current generated by the further fuel cell system by the electrical signal.

18. The device according to claim 4, wherein, as a result of the applied temporally offset oscillation of the first electrical current and of the further electrical current, a voltage in the first fuel cell system and a voltage in the further fuel cell system are temporarily increased or decreased.
